(19) United States
(12) Patent Application Publication
(10) Pub. No.: US 2004/0001494 A1
(43) Pub. Date: Jan. 1, 2004

(54) Architecture for obtaining playback time from a packet sequence number in AAL2 SSCS voice

(75) Inventors: Craig I. Barrack, Irvine, CA (US); James Yik, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Zarlink Semiconductor V.N. Inc, Irvine, CA (US)

(21) Appl. No.: 10/186,438

(22) Filed: Jul. 1, 2002

(51) Int. Cl. H04L 12/56; H04L 12/54

(52) U.S. Cl. 370/395.61; 370/352; 370/356

(57) ABSTRACT

Architecture for generating a playback time from a AAL2 SSCS voice packet sequence number in a stream-based application. The architecture comprises an event scheduler engine for initiating control parameters for an interpretive window associated with a packet stream; a sliding window engine for controlling the interpretive window according to the control parameters; and an arrival engine that maps the packet sequence number to an expected playback time in accordance with an association created between the packet sequence number and the expected playback time by the interpretive window.

### BACKGROUND OF THE INVENTION

This invention is related to carrying voice over digital packet switched networks, and more specifically, the processing of VoIP over ATM.

In the world of ATM (Asynchronous Transfer Mode), a new adaptation layer was required to provide the flexibility for network operators to control delay on voice services and to overcome the excessive bandwidth needed by using structured circuit emulation. Such an implementation has offered cellular communication engineers an alternative transfer mode for voice transmission over digital regimes, and in particular voice over IP (VoIP).

This new adaptation layer, known as AAL2 (ATM Adaptation Layer 2), was designed to make use of the more statistically multiplexible Variable Bit Rate ATM traffic classes, providing bandwidth-efficient transmission of low-rate, short, and variable packets for delay-sensitive applications. This means AAL2 is not limited to ATM connections using the Constant Bit Rate traffic class. AAL2 also supports voice applications using higher layer requirements, such as voice compression, silence detection/suppression, and idle channel removal.

The most important benefit of AAL2 is the substantial reduction of bandwidth needs for supporting voice on ATM networks, driving down network costs. A further benefit is obtained by the inherent flexibility to add features via the SSCS sub-layer structure, of which different fixed compression techniques and voice channel switching between ATM circuits, are examples. The ability to add dynamic interconnection between ATM network elements (switches/concentrators) and existing telephony devices (like PBXs for setup and tear-down of ATM voice connections) provides even greater cost/bandwidth efficiencies and flexibility.

The AAL2 structure, as defined in ITU-T Recommendation I.363.2 (International Telecommunication Union—Standardization Sector), is divided into two sub-layers: the Common Part Sub-layer (CPS) and the Service Specific Convergence Sub-layer (SSCS). In the ITU-T Recommendation I.363.2, the SSCS is defined as the link between the AAL2 CPS and the higher layer applications of the individual AAL2 users. One of two SSCS Recommendations that have been developed in the ITU-T is Recommendation I.366.2 directed to the AAL2 SSCS for trunking, which provides a rich set of features for voice users of AAL2. Some of the features in I.366.2 include compressed voice, silence indication, alarm handling, channel associated signaling, dialed digits, and fax demodulation and remodulation.

However, the inherent constant and variable bit rates of voice packets being shipped over ATM, and the numerous routing paths over which the voice packets can be shipped to the receiving end, all contribute to the potential for disruption and/or distortion of the voice stream to the listener at the receiving end. The calculation of an accurate playback time for each packet in a VoIP application is critical to playing out the audio samples without distortion. Thus is becomes important to the success of such an AAL2 SSCS system to facilitate the playback of those voice packets at the receiving end in an orderly and efficient manner.

What is needed is architecture that can determine unambiguously, even after extremely short periods of silence or loss of packets, which packet is received and when that packet should be played back, that is, to ensure the calculation of accurate playback time for each packet in a VoIP ATM environment.

### SUMMARY OF THE INVENTION

The present invention disclosed and claimed herein, in one aspect thereof, comprises architecture for generating a playback time from a AAL2 SSCS voice packet sequence number in a stream-based application. The architecture comprises an event scheduler engine for initiating control parameters for an interpretive window associated with a packet stream; a sliding window engine for controlling the interpretive window according to the control parameters; and an arrival engine that maps the packet sequence number to an expected playback time in accordance with an association created between the packet sequence number and the expected playback time by the interpretive window.

When a change in a packet payload is detected, translation information utilized to translate the packet sequence number to the expected playback time data is adjusted, and the scheduler engine is interrupted to adjust a frequency at which an interpretive window shifts through a series of corresponding arrival windows.

### BRIEF DESCRIPTION OF THE DRAWINGS

For a more complete understanding of the present invention and the advantages thereof, reference is now made to the following description taken in conjunction with the accompanying drawings, in which:

FIG. 1 illustrates a graphic representation of calculated playback times of a stream of 20-byte packets utilizing a 2-bit timestamp;

FIG. 2 illustrates a graph indicating how packet arrival time can be used to resolve ambiguity in calculating the playback time;

FIG. 3 illustrates a graphic representation of a sliding window;

FIG. 4 illustrates a scenario where two packets with the same 2-bit timestamp arrive separated by a “short” interval;

FIG. 5 illustrates a functional partition of basic implementation of the AAL2 SSCS mapping module algorithm, according to a disclosed embodiment;

FIG. 6 illustrates a time-indexed data structure used by the event scheduler engine of the AAL2 SSCS mapping algorithm module;

FIG. 7 illustrates the evolution of a trailing edge of a sliding (or interpretive) window as the sliding window moves along an arrival time scale, in a case where a packet with changed payload size arrives in its arrival window;

FIG. 8 illustrates a scenario where a packet with a changed payload size arrives late in its arrival window;

FIG. 9 illustrates a scenario where the packet with a changed payload size arrives outside of its arrival window;

FIG. 10 illustrates an alternative embodiment to the implementation of FIG. 5, when considering the need to support occasional payload change;

FIG. 11 illustrates a revised data structure 1100 used by the event scheduler, showing two additional fields that are useful in dequeuing and requeuing events; and

FIG. 12 illustrates an ATM voice system that utilizes the disclosed mapping architecture.

### DETAILED DESCRIPTION OF THE INVENTION

This invention provides an algorithm and implementation for mapping a packet sequence number associated with AAL2 (ATM Adaptation Layer 2) SSCS (Service Specific Convergence Sublayer) architecture to a playback time referenced to the local clock. The disclosed algorithm is developed for implementation with existing hardware. The calculation of an accurate playback time for each packet in a VoIP (Voice over IP) application is critical to playing out the audio samples without distortion. This problem is especially difficult for AAL2 SSCS for at least two reasons: (1) the packet sequence number is at most four bits; and (2) some packets may never arrive if a voice processor determines that the packet payload is “silent”, that is, the signal energy contained in the voice samples falls below a fixed threshold. In order to save network bandwidth, such silent packets are sometimes “suppressed”—that is, not transmitted to the destination.

The combined effects of (1) and (2) make the process of calculating playback time from a sequence number challenging. For example, consider receiving consecutive packets with sequence numbers 12, 2, 6, 11, 11, 10, and 6. The fact that some packets may never arrive, when combined with the low resolution of the packet sequence number, makes playback of these packets at the correct times a difficult proposition.

Although the ITU (International Telecommunication Union) specification calls this field a “sequence number,” hereinafter, the terms “timestamp” or “sender timestamp” are used to refer to the sequence number on an AAL2 SSCS packet, since the terms more accurately reflect the field usage.

Each packet playback time is computed from a timestamp inserted by the sender into the packet header. The unit by which time is measured has been pre-negotiated, and is typically equal to 125 μs (microseconds). The mapping function is a simple additive translation,

tₚ=f(tₛ)=tₛ+D,

where tₛ is the sampling time of the audio, tₚ is the calculated playback time, and D is the addend used by the mapping function f. If tₛ is a high-resolution timestamp field in the packet header (e.g., thirty-two bits) capable of representing a range of time up to 2³²×125 μs, i.e., more than six days worth-the sender timestamp is always unambiguous. For example, if a gap of forty time units appears in the sequence of voice packets arriving at the receiver, then there is no question that 40×125 μs=5 ms of “comfort noise” should be inserted. Comfort noise is inserted by the destination device when a gap is detected in the sequence of packets. Such a gap is typically the result of silence suppression at the source device. Hypothetically, the same gap could mean that six days of comfort noise should be inserted, but clearly this is not the best interpretation.

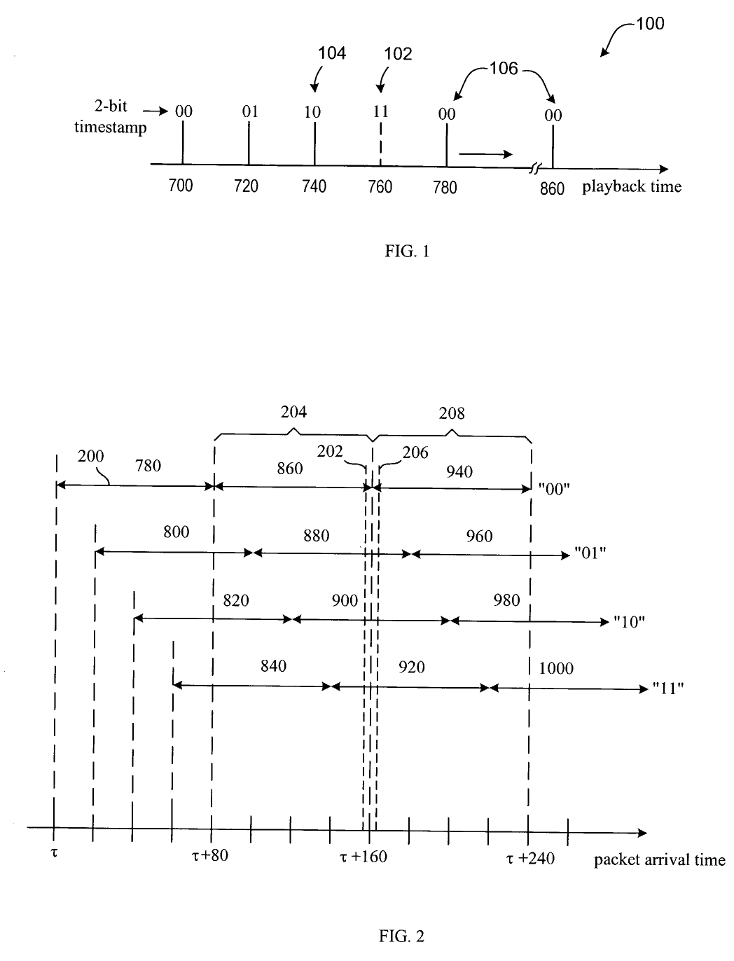

Referring now to FIG. 1, there is illustrated a graphic representation of calculated playback times of a stream of 20-byte packets utilizing a 2-bit timestamp. In this particular embodiment, a voice stream 100 of 20-byte packets arrives at a mapping module. If no packets were ever lost, or suppressed because of silence, then 2-bit resolution of the timestamp would not matter, since the playback time could be calculated relative to preceding packets using the simple recurrence:

tₚ(m)=tₚ(m−1)+20,

where tₚ(m) is the playback time of the m^{th} packet of a voice stream. This behavior is observed with the first three packets having the respective timestamps of “00”, “01”, and “10”.

In reality, however, gaps in the sequence of timestamps will indeed occur. For example, in the 20-byte packet stream 100, if no packets where missing, a fourth 20-byte packet 102 is expected at a playback time of 760 having a timestamp “11.” However, where the fourth packet 102 is missing, a gap occurs between a third packet 104 (having the associated timestamp of “10”) and the next packet 106 received, which is expected to have a “00” timestamp. Such gaps are interpreted as lost or silence-suppressed packets, and a playback engine (described in greater detail hereinbelow) must then insert the comfort noise.

The problem is that the resolution associated with a 2-bit timestamp is insufficient to unambiguously allow computation of gap sizes, and therefore, the amount of comfort noise to be inserted. For example, when the next packet 106 having the associated with the timestamp “00” arrives, following the third packet 104 with timestamp “10”, a gap occurs that requires the insertion of comfort noise, since the expected fourth packet 102 never arrived. However, the size (or time duration) of the gap is unknown. As illustrated, it now cannot be determined with certainty whether the most recent next packet 106 should be mapped to a playback time of 780, 860, or for that matter, 940 or 1020. The coarse resolution of the existing 2-bit timestamp has a detrimental impact, because unlike the increased certainty provided with a higher resolution timestamp, e.g., a 32-bit timestamp, the lower resolution 2-bit timestamp allows the introduction of many reasonable interpretations of the playback time associated with the gap left by the missing expected fourth packet 102 in the observed sequence of timestamps.

The scenario presented hereinabove is not purely hypothetical. In the AAL2 SSCS architecture, the sender timestamp has a resolution of at most four bits, depending on the profile. For purposes of this description, a timestamp is utilized with two bits of resolution. However, the disclosed mapping algorithm architecture supports all data structures up to four bits of resolution.

For each packet sent or suppressed, the timestamp increases by one. For a given voice packet stream 100, the payload size is considered fixed (as in FIG. 1), although the effect of on-the-fly changes in payload sizes on the disclosed algorithm will be addressed hereinbelow. Note also that all references to payload size are defined to mean decompressed payloads. If the packet is compressed, the size of the packet after decompression must be computed in order to perform the operations described herein.

As indicated hereinabove, when computing the playback time for a voice packet, ambiguity presented by the AAL2 SSCS timestamp needs to be resolved. One logical way to do this is to use the current time—the time at which the computation is performed—as an interpreter of the sender timestamp. In other words, the new mapping equation becomes a function of the current time, defined by tₚ=f(tₛ, current time).

Referring again to FIG. 1, since the packet lengths are twenty bytes, the next packet 106 with timestamp “00” could have a playback time of 780, 860, 940, etc. The new mapping equation indicates that the current time should be used to resolve the ambiguity. In other words, if the next “00” packet 106 arrives “around the time when a packet with the playback time of 780 would be expected to arrive,” then the next “00” packet 106 is assigned the playback time of 780. Similarly, if the next “00” packet 106 arrives “around the time when a packet with the playback time of 860 would be expected to arrive,” then the next “00” packet 106 is assigned the playback time of 860.

Referring now to FIG. 2, there is illustrated a graph indicating how packet arrival time can be used to resolve ambiguity in calculating the playback time. There are provided arrival windows and the associated playback times for packets with each of the four timestamp values. It is observed that packets with timestamp “00” (denoted along the time scale 200 of arrival windows) can be assigned playback times of 780, 860, 940, and so on. Thus time can be divided into 80-byte arrival windows, so that a packet with a “00” timestamp (i.e., a “00” packet) can be mapped unambiguously to a corresponding playback time. For example, if the “00” packet arrives at a time t+158 (denoted as time 202), which time 204 lies in an arrival window 204, then that “00” packet is assigned the playback time of 860. If the “00” packet arrives at time t+162 (denoted as time 206), which time 206 lies in an arrival window 208, then the “00” packet is instead assigned the playback time of 940.

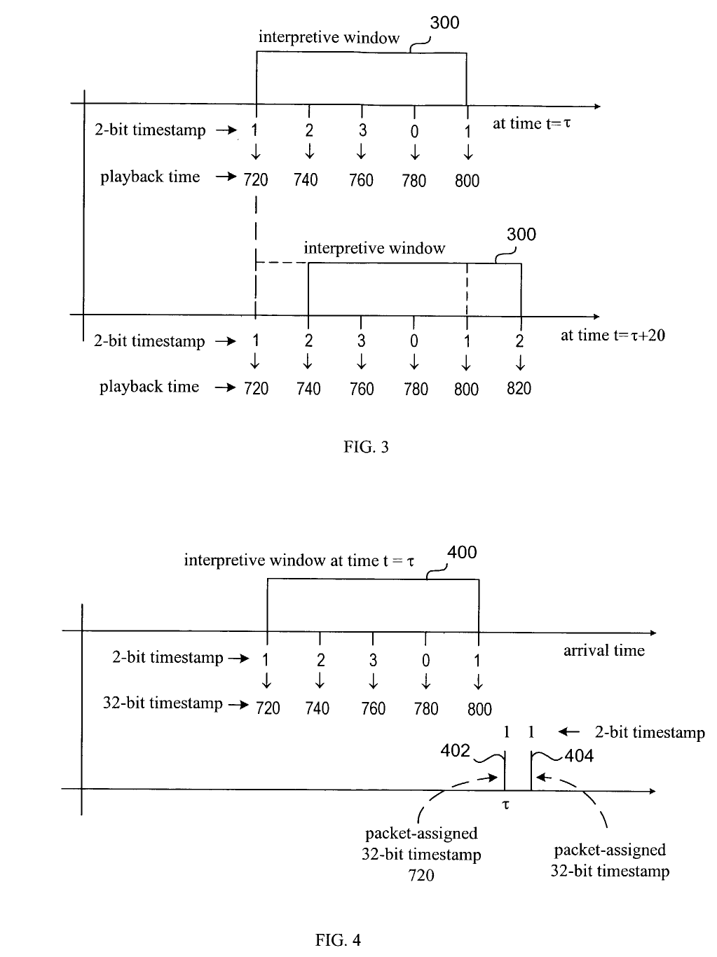

Referring now to FIG. 3, there is illustrated a graphic representation of an alternate method utilizing a sliding window 300. Hereinafter, the value of the timestamp is denoted as a decimal representation of the 2-bit binary number integer where the sender timestamp is incremented by one for each packet. Here, the single interpretive window 300 is the same size as the arrival window 200, and slides with time representing the desired mapping. At time t, a first packet with a timestamp “1” is assigned to playback time 720. By contrast, at time t=t+20, a second packet with timestamp “1” is assigned to playback time 800. As observed, the sliding-window representation allows efficient computation of the playback time from the sender timestamp.

To this point, the process of mapping the sender timestamp (of between zero and four bits) to a playback time has been based upon the local TDM (Time Division Multiplexing) clock. Hereinafter, this process is divided into two pieces:

Tₛ=f(tₛ, current time) and

tₚ=f(Tₛ)=Tₛ+D,

where Tₛ is a 32-bit timestamp generated from the coarse resolution timestamp tₛ. Rather than using the sender timestamp tₛ to directly compute a playback time tₚ, the coarse resolution timestamp tₛ is mapped to a higher resolution timestamp Tₛ. Once the higher resolution timestamp Tₛ is known, is becomes a simple process utilizing the additive translation factor D to determine the playback time. Thus the problem of computing a packet playback time is reduced a matter of increasing the resolution of the sender timestamp.

Referring now to FIG. 4, there is illustrated a scenario where two packets with the same 2-bit timestamp arrive separated by a “short” interval, where a short interval is defined as the time less than the time duration of a single packet. Under such circumstances, two packets associated with arrival times 402 and 404, and with a timestamp “1” arriving within the short interval would ordinarily be assigned to the same 32-bit timestamp, and thus the same playback time. However, since the interpretive window 400 (also called the sliding window) does not move continuously through time such that an edge can move between the arrival time of the first packet (with the arrival time 402) and the second packet (with the arrival time 404), but moves in discrete steps of time according a single packet time, the second packet with the arrival time 404 is interpreted as a duplicate, and will be discarded. The issues of detecting such a scenario are further described hereinbelow.

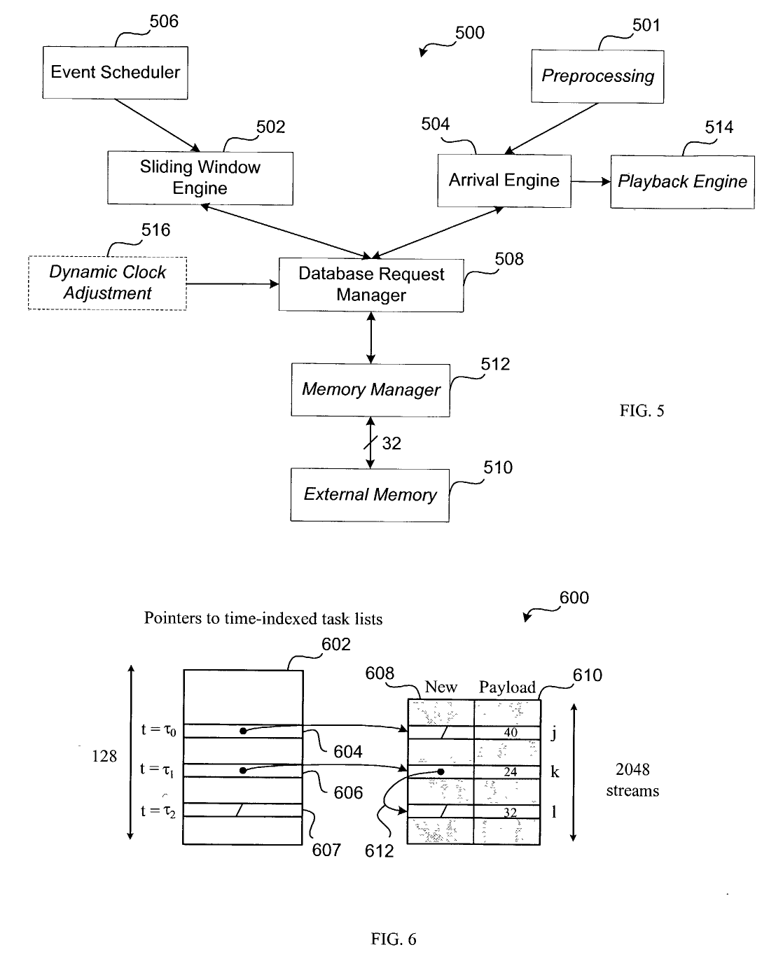

Referring now to FIG. 5, there is illustrated a functional partition of basic implementation of the AAL2 SSCS mapping module algorithm 500, according to a disclosed embodiment. For purposes of this embodiment, the payload length for a given voice stream is fixed. The scenario where the payload length of the received packets changes, will be described hereinbelow. Interfacing modules are shown in italics.

The mapping algorithm 500 is implemented utilizing three engines, which engines operate on the sender timestamp received into the algorithm from a preprocessing interface 501. Thus the preprocessing interface 501 generally encompasses all of the processes for receiving the TDM packet stream of interleaved packets comprising multiple channels voice information, separating the packet stream into individual packets, extracting the sender timestamp (i.e., the packet sequence number) and forwarding the sender timestamp to the arrival engine 504. The three principal engines include: a sliding window engine 502 that shifts the interpretive window for a given stream when triggered; an arrival engine 504 that performs mapping of an incoming packet timestamp to a playback time, using the interpretive window; and, an event scheduler engine 506 that triggers the window sliding behavior of the multi-channel AAL2 voice streams (e.g., 2,048) at the appropriate times. Note that the processes being performed in the arrival engine 504 occur in parallel with the processes performed in both the event scheduler 506 and the sliding window engine 502.

The sliding window engine 502 and arrival engine 504 operate on a common database stored in an external memory 510, and accessible through a database request manager 508. The database contains one entry per AAL2 voice stream. To access the database, the database request manager 508 communicates with a memory manager 512 that functions as the interface to the external memory 510. Note that the external memory 510 may be a high speed chip memory, or a slower non-volatile mass storage device such as a hard drive or optical drive. Still further, the database may reside on the non-volatile mass storage medium, and when required for use, all or selected portions thereof are moved into, or cached in the faster chip memory for faster access by the data request manager 508. The fields in this database are the following, with the number of bits indicated in parenthesis:

Resolution(3)—indicates the resolution of the sender timestamp (between zero and four bits);

TS_at_Trailing_Edge(4)—indicates the sender timestamp associated with the trailing edge of the sliding window (e.g., in FIG. 4, TS_at_Trailing_Edge=1);

Translated_TS_at_Trailing_Edge(32)—records the translated 32-bit timestamp associated with the trailing edge of the sliding window (e.g., in FIG. 4, Translated_TS_at_Trailing_Edge=720);

Next_Expected(5)—indicates the sender timestamp associated with the next expected packet; if no packet is currently expected, the high order bit is set to one;

d₀(10)—accounts for the difference between the translated 32-bit timestamp based on the remote clock, and the packet arrival time based on the local clock;

d₁(10)—stores the programmable playback delay (up to 128 ms); and

Payload(8)—indicates the payload size associated with this stream.

When the event scheduler 506 triggers a particular voice stream, the sliding window engine 502 sends a read request to the database request manager 508. Upon receiving a response from the database request manager 508 that the event scheduler 506 has now been given priority to update the database by modifying the data read therefrom, the sliding window engine 502 performs the necessary calculations, and then sends a write request back to the database request manager 508 to update selected fields in the database. When the write request is approved by the database request manager 508, the updated data is written back to the database via the database request manager 508. The database fields to be updated are the following:

Next_Expected—if TS_at_Trailing_Edge is equal to Next_Expected, then increase Next_Expected by one, modulo 2^{Resolution}; if the high order bit of Next_Expected is equal to one, then set Next_Expected to TS_at Trailing_Edge; otherwise, do not update this field;

TS_at_Trailing Edge—increases by one, modulo 2^{Resolution}; and

Translated_TS_at_Trailing_Edge—increases according to the payload.

When a job for a packet arrives from the preprocessing interface 501, the arrival engine 504 sends a read request to the database request manager 508. Upon receiving a response from the database request manager 508 that the arrival engine 504 has now been given priority to update the database by modifying the data read therefrom, the arrival engine 504 performs the following necessary calculations to assign a playback time to the packet:

If the difference between the sender timestamp and TS_at_Trailing_Edge, modulo 2^{Resolution}, is less than the difference between Next_Expected and TS_at_Trailing_Edge, modulo 2^{Resolution}, then the packet must be discarded;

To calculate the 32-bit timestamp, take the sender timestamp minus TS_at_Trailing_Edge, modulo 2^{Resolution}, and then multiply by the payload. This multiplication is performed by parallel additions. The number of parallel processes is equal to the exponent term Resolution (at most four).

Then add the result to Translated_TS_at_Trailing_Edge. Add in d₀ and d₁ to compute the playback time.

A job can now be sent to a playback engine 514. The arrival engine 504 then sends a write request to the database request manager 508. Once the database request manager 508 has given priority to the arrival engine 504, the updated data is written back from the arrival engine 504 to the database via the database request manager 508. The database field to be updated is Next_Expected, which generally increases by one, modulo 2^{Resolution}. If this operation would cause Next_Expected to equal TS_at Trailing_Edge, then instead, set the high order bit to one to indicate no packet is expected.

The sliding window engine 502 periodically updates the database to reflect changes in location of the interpretive window and associated timestamp mappings. When a packet arrives, the arrival engine 504 reads from the database, obtains the needed information about the interpretive window, and then either discards the packet or computes its playback time based upon what has been read.

A dynamic clock adjustment block 516 sends timing signals to the database request manager 508.

Referring now to FIG. 6, there is illustrated a time-indexed data structure 600 used by the event scheduler engine 506 of the AAL2 SSCS mapping algorithm module 500. As indicated hereinabove, the sliding window engine 502 periodically performs a database update for each AAL2 voice stream. These periodic updates are triggered in response to an increment of a playback clock of the playback engine 514. Each time the playback clock increments a playback time, the event scheduler 506 triggers all streams in a task list array 602 where each row constitutes one task list, and each row is indexed by the time at which the task list is to be completed. Thus when the playback clock increments to a first time t=τ₀, a corresponding first task list 604 that is a set of tasks, is completed, i.e., updated by mapping that sender timestamp to a higher resolution timestamp. The first task list 604 includes one element—the stream j. Similarly, when the playback clock increments to a second time t=τ₁, a corresponding a second task list 606 that is a set of tasks, is completed, i.e., updated by mapping that sender timestamp to a corresponding higher resolution timestamp. The second task list 606 includes two elements—the streams k and 1, where a pointer 612 links the two streams k and 1 in a new task list 608 to the second indexed time t=τ₁. A third task list 607 is the set of tasks that need to be completed at a third time t=τ₂. However, this third task list 607 is empty. And so on, to further time-indexed task lists that are not shown, but indicated by the double headed arrow.

Note that in this particular embodiment, the task list array 602 contains one hundred twenty-eight time indexes. Thus no task will ever be scheduled more than one hundred twenty-eight time units (i.e., 128×125 μs) in the future. This equivalent to saying that no payload will ever exceed one hundred twenty-eight bytes.

For each stream (or task list 604 and 606) triggered for updating by the incrementing playback clock, a message is sent to the sliding window engine 502. The message signals the sliding window engine 502 to shift the interpretive window 300 for stream context j. As mentioned hereinabove, when the playback clock increments to a certain time, each stream associated with that particular time index in the task list array 602 is then delinked from the current task list array 602, and then is relinked to the new task list 608 and a corresponding payload list 610. This linking operation is a mapping function, in that the first task list 604 of the current task list array 602 is mapped to a new (or updated) time, created as the sum of the current time of the playback clock plus the time duration of the stream-configured payload size of the first task list 604 (in this particular example, a payload size of forty). Similarly, the second task list 606 of the current task list array 602 is mapped to a new (or updated) time created as the sum of the current time of the playback clock and the time duration of the stream-configured payload size of the second task list 604 (in this particular example, a payload size of twenty-four).

The database request manager 508 processes requests from the sliding window engine 502, the arrival engine 504, and the dynamic clock adjustment sub-block 516. The dynamic clock adjustment sub-block 516 requests a database update whenever d₀ needs to be adjusted by one time unit in either direction, because of clock drift detected between the local and remote clocks.

Because the sliding window engine 502, the arrival engine 504, and the dynamic clock adjustment sub-block 516 all perform read-modify-write accesses, the database request manager 508 must be sufficiently capable of arbitrating among the three requesting entities. In particular, when one module (e.g., the sliding window engine 502) requests a database read in order to modify the database entry, the database request manager 508 must not grant any additional memory accesses by another module (e.g., the arrival engine 504) until the same module has performed a write, thereby completing the read-modify-write operation.

Because of network conditions, the sender may occasionally change the number of samples packed into a single payload unit. In AAL2 SSCS, the only way the receiver can detect such a payload change is to actually examine each packet as it arrives.

All three engines (sliding window engine 502, arrival engine 504 and event scheduler engine 506) of the AAL2 SSCS mapping sub-block must cooperate when the payload size changes for a given stream. First, the arrival engine 504 detects the change by determining the payload size of the incoming packet. Second, the sliding window engine 502 changes the translation between the sender timestamp and 32-bit timestamp. Third, the event scheduler 506 slides the interpretive window at a different frequency according to the payload size, i.e., a higher frequency for a larger payload and a lower frequency for a smaller payload. Note that the typical case of payload change is straightforward.

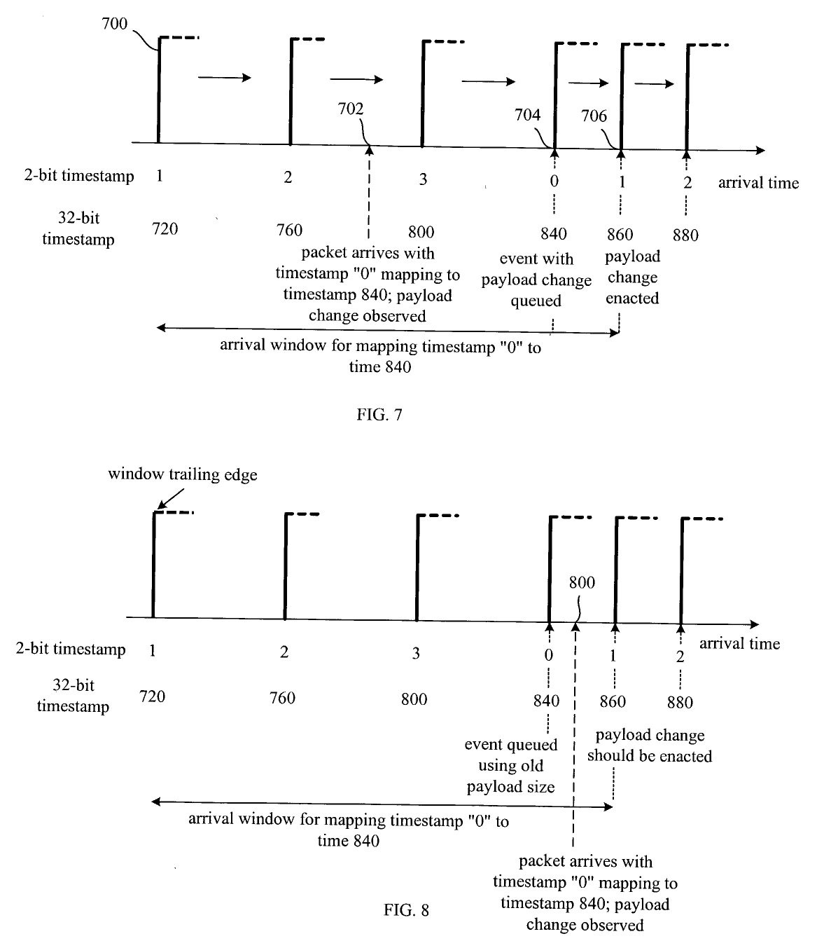

Referring now to FIG. 7, there is illustrated the evolution of a trailing edge 700 of a sliding (or interpretive) window as the sliding window moves along an arrival time scale, in a case where a packet with a changed payload size arrives in its arrival window. Up to this point, the description has embodied 20-byte packets. In this particular embodiment, the packet payload changes from forty bytes to twenty bytes. Thus initially, the arrival window is 160-bytes wide to process 40-byte payloads, and the sliding window steps downs the arrival time axis such that its trailing edge 700 moves in 40-byte increments.

The next expected payload has a sender timestamp of “0” and a 40-byte payload, and is expected to be mapped to the high resolution “840” timestamp. However, a new packet with a “0” timestamp and a reduced payload size (e.g., now a 20-byte payload) arrives at a time 702, which time 702 is located somewhere between the 2-bit timestamps of “2” and “3” of the 160-byte arrival window. The sliding window engine determines that the packet payload size has now changed from forty bytes to twenty bytes.

At some later time, at an event time 704, when the trailing edge 700 of the sliding interpretive window moves to the subsequent timestamp “0” position, the change in payload size must be accommodated. Thus this event and the amount of payload change is queued for processing by the event scheduler 506, at the event time 704. The event value is then enacted at an enactment time 706 (associated with the timestamp of “1”) by the event scheduler 506, which event value is the current time plus the time duration associated with the new payload size of twenty, and not the time duration associated with the old payload size of forty bytes. That is, the new time parameters associated with the new payload change are enacted at the enactment time 706, which is triggered so that the trailing edge 700 steps twenty time units later than the event time 704 (or twenty time units sooner relative to the earlier packet payload size regime of forty). Thus further processing according to the changed payload size is now complete.

Referring now to FIG. 8, there is illustrated a scenario where a packet with a changed payload size arrives late in its arrival window. Here, the 20-byte packet of FIG. 7, with a timestamp of “0”, arrives at a late time 800 that is after its arrival window (that ends at the time 840). Although the packet is detected as having a payload size of twenty, an event time has already been created forty time units from the last window shift. In order for the next window shift to be performed correctly, the arrival engine 504 must interrupt the event scheduler 506, dequeue the event based upon the old payload size, and requeue an event based upon the new payload size.

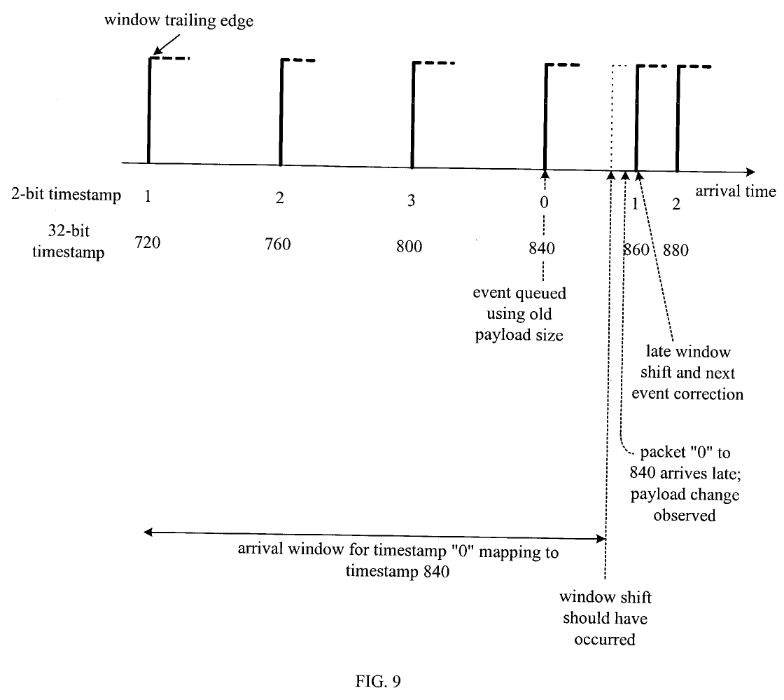

When the first packet with a new payload size arrives late in its arrival window, the effect is almost always straightforward. Unfortunately, there does exist one case that is not so straightforward. Referring now to FIG. 9, there is illustrated a scenario where the packet with a changed payload size arrives outside of its arrival window. Under such circumstances, the interpretive window must immediately be shifted, perhaps even several times, if the decrease in payload size is substantial.

As a final observation on payload change, if the first packet with a new payload size is lost, it is unknown how to slide the interpretive window properly. In this case, it is assumed that the first packet actually observed to have a new payload size is indeed the first packet with a new payload size.

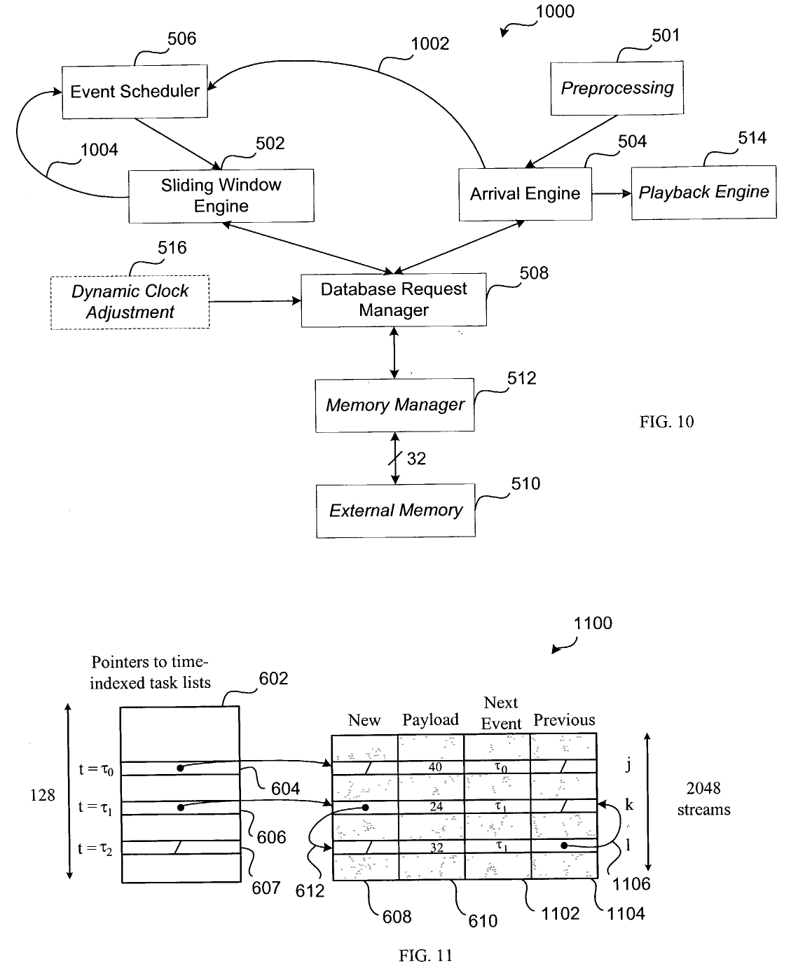

Referring now to FIG. 10, there is illustrated an alternative embodiment 1000 to the implementation of FIG. 5, when considering the need to support occasional payload change. In particular, two additional feedback paths are added. A first feedback path 1002 is added from the arrival engine 504 to the event scheduler 506, and a second feedback path 1004 is added from the sliding window engine 502 to the event scheduler 506. These feedback paths to the event scheduler 506 allow a change of the frequency at which the interpretive window shifts after a payload change has been detected. The database shared by the arrival engine 504 and the sliding window engine 502 also contains the following three new fields:

Old_Payload(8), which indicates the payload size currently associated with this stream. This field was previously called Payload;

New_Payload(8), which indicates the new payload size to be associated with this stream, following a payload change; and

Change_PL_When(5), which stores the sender timestamp associated with the first packet, to reflect the new payload size. If no payload change is indicated, the high order bit is set to one.

In this new implementation 1000, when the event scheduler 506 triggers a particular voice stream, the sliding window engine 502 sends a read request to the database request manager 508. Upon receiving a response from the database request manager 508 allowing priority to the event scheduler 506 to retrieve the database information, the sliding window engine 502 performs the necessary calculations, and then sends a write request to the database request manager 508 to update selected data fields. Once approved by the database request manager 508, the event scheduler 506 updates the following database fields:

Next_Expected. If TS_at_Trailing_Edge is equal to Next_Expected, then increase Next_Expected by 1, modulo 2^{Resolution}. If the high order bit of Next_Expected is equal to one, then set Next_Expected to TS_at_Trailing_Edge. Otherwise, do not update this field;

Translated_TS_at_Trailing_Edge. If Change_PL_When is equal to TS_at_Trailing_Edge, then increase Translated_TS_at_Trailing_Edge by New_Payload. Otherwise, increase Translated_TS_at_Trailing_Edge by Old_Payload;

Change_PL_When. If Change_PL_When is equal to TS_at_Trailing_Edge, then set the high order bit of Change_PL_When to one;

Old_Payload. If Change_PL_When is equal to TS_at_Trailing_Edge, then set Old_Payload to New_Payload; and

TS_at_Trailing_Edge. Increases by one, modulo 2^{Resolution}.

If a payload change has been detected by the sliding window engine 502, it updates its mapping by using the new payload instead of the old payload in its calculation of Translated_TS_at_Trailing_Edge. In addition, the sliding window engine 502 must notify the event scheduler 506 of the payload change, so that the event scheduler 506 will trigger future window shifts at the correct times.

When a job for a packet arrives, the arrival engine 504 sends a read request to the database request manager 508. Upon receiving a response from the database request manager 508 allowing the arrival engine 504 to read database information, the arrival engine 504 performs the necessary calculations to assign a playback time to the packet:

If the difference between the sender timestamp and TS_at_Trailing_Edge, modulo 2^{Resolution}, is less than the difference between Next_Expected and TS_at_Trailing_Edge, modulo 2^{Resolution}, then the packet must be discarded.

The 32-bit timestamp is calculated by first computing an intermediate value σ. If the high order bit of Change_PL_When is equal to one, then cy is defined to be the sender timestamp minus TS_at_Trailing_Edge, modulo 2^{Resolution}, multiplied by the old payload. If the high order bit of Change_PL_When is equal to zero, and if the difference between the sender timestamp and TS_at_Trailing_Edge, modulo 2^{Resolution}, is less than the difference between Change_PL_When and TS_at_Trailing_Edge, modulo 2^{Resolution}, then σ is defined as the same as above. Otherwise, define σ₀ to be Change_PL_When minus TS_at_Trailing_Edge, modulo 2^{Resolution}, multiplied by the old payload. Define σ₁ to be the sender timestamp minus Change_PL_When, modulo 2^{Resolution}, multiplied by the new payload. Then let σ=σ₀+σ₁.

Add σ to Translated_TS_at_Trailing_Edge to obtain the 32-bit timestamp, and add in d₀ and d₁ to compute the playback time.

A job can now be sent to the playback engine 514. The arrival engine 504 then sends a write request to the database request manager 508. Once granted to do so, the arrival engine writes to update the following database fields:

Next_Expected. Generally increases by one, modulo 2^{Resolution}. If this operation would cause Next_Expected to equal TS_at_Trailing_Edge, then instead set the high order bit to one to indicate no packet is expected;

New_Payload. If a payload change is detected, the payload length of the arriving packet must be written to this field; and

Change_PL_When. If a payload change is detected, the sender timestamp of the arriving packet must be written to this field.

If a payload change has been detected, and the sender timestamp is equal to TS_at_Trailing_Edge, then the algorithm is experiencing one of the cases illustrated in FIG. 8 and FIG. 9. That is, because the first packet with a new payload size has either arrived late in or outside its arrival window, the arrival engine 504 must immediately interrupt the event scheduler 506, so that an adjustment can be made.

Because of the need to dequeue and requeue events after a payload change, the time-indexed data structure of the event scheduler 506 requires two additional fields.

Referring now to FIG. 11, there is illustrated a revised time-indexed data structure 1100 used by the event scheduler 506, showing two additional fields (a next event field 1102 and a previous field 1104) that are useful in dequeuing and requeuing events.

In response to each increment of the playback clock, the event scheduler 506 triggers all streams in the task list array 602 for the row indexed by the current time. For each stream triggered, a message is sent to the sliding window engine 502. In this particular embodiment, where a payload change has occurred, the message not only signals the sliding window engine 502 that it is time to shift the interpretive window 300, as before in FIG. 6, but also indicates how many times to slide the interpretive window 300, since multiple shifts may be required. Each stream is delinked from the current task list array 602, and then is relinked to the new task list array 608 indexed by the current time plus configured payload size 610 of the stream. The added next event field 1102 is updated to record the time-indexed list that the stream is in. Thus stream j is in the t=τ₀ list, and streams k and 1 are in the t=τ₁ list. The previous column 1104 includes a pointer 1106 that references stream 1 to its previous stream at that indexed time, stream k.

When either the arrival engine 504 or the sliding window engine 502 notifies the event scheduler 506 of a payload change for a voice stream, the following steps are performed: the event scheduler 506 reads the corresponding next event time 1102 for that stream; the stream is deleted from the current task list array 602; the old payload size is subtracted from the next event time 1102, and then the new payload size is added in. If the result R is less than or equal to the current time, then the new payload size is repeatedly added until the result R is greater than the current time, while counting the number of times Q that the new payload size was added (not counting the first time). The payload size field 610 is then updated to reflect the new payload size; the next event time field 1102 is updated with the value R, and the stream is reinserted into the next task list 608 indexed by time R. If necessary, the event scheduler 506 sends Q requests to the sliding window engine 502.

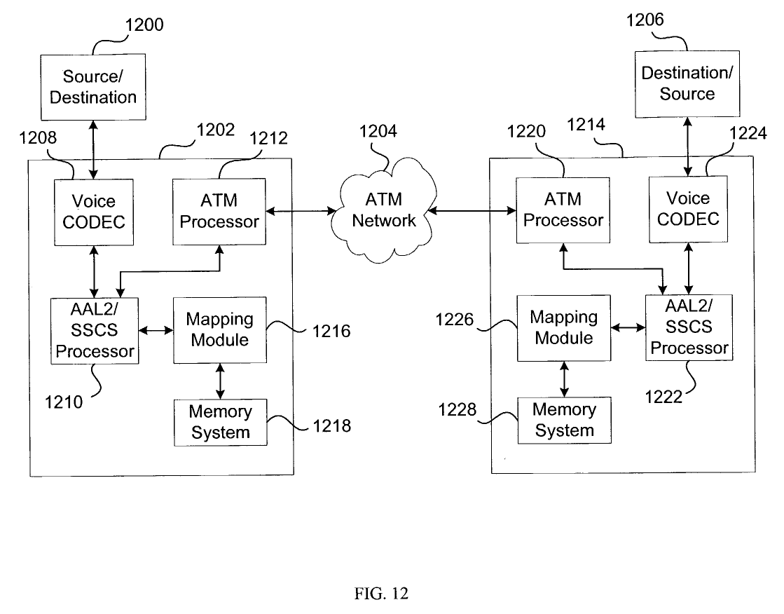

Referring now to FIG. 12, there is illustrated an ATM voice system that utilizes the disclosed mapping architecture. A source 1200 introduces voice signals into a source ATM voice processing system 1202 for processing and transmission across an ATM network 1204 to a destination 1206. The voice signals from the source 1200 are input to a source encoder/decoder (Codec) 1208 for compression. It is appreciated that the source processing system 1202 is suitably designed to accommodate the processing and transmission of a plurality of voice channels from the source 1200, which voice channels carrying respective voice signals. The compressed voice stream (typically compressed from 64 kbps to 32 kbps utilizing, e.g., ADPCM—Adaptive Differential Pulse Code Modulation) is then passed to a source AAL2/SSCS processor 1210. The source AAL2 processor 1210 converts the ADPCM traffic into AAL2 packets for insertion into the ATM stream. Additionally, the packet sequence number (or sender timestamp) is assigned. A source ATM processor 1212 receives the AAL2 packets from the source AAL2 processor 1210 and performs the insertion process, prior to transmitting the compressed voice AAL2 SSCS traffic over the ATM network 1204 to a destination ATM voice processing system 1214. Note that since this is a bi-directional system, a source mapping module 1216 (similar to mapping module 1000) and associated source memory system 1218 in the source voice processing system 1202 are used only when voice streams are received from the destination 1206, and require playback to the source 1200.

When the compressed voice AAL2 SSCS traffic is received into the destination ATM voice processing system 1214, a destination ATM processor 1220 performs cell header and error processing, and ships the AAL2/SSCS packets to a destination AAL2/SSCS processor 1222. Conventionally, the destination AAL2 processor 1222 then performs buffering for build-out delay in playback to a destination codec 1224, and the packet sequence number is also used to decide the order of playback to the destination codec 1224. However, in this novel embodiment, the packet sequence number is passed from the destination AAL2 processor 1222 to the mapping module 1226 (similar to mapping modules 1216 and 1000) where the high resolution mapping occurs according to the variable payload of the voice packets, as described in detail hereinabove. The mapping module 1226 encompasses the sliding window engine 502, arrival engine 504, event scheduler 506, and database request manager 508. The destination ATM processor 1220 and AAL2/SSCS processor 1222 perform the functions associated with the preprocessing block 501. A destination memory system 1228 (comprising the memory manager 512 and memory 510, and similar to memory system 1218) supports the database of parameters.

The destination AAL2/SSCS processor 1222 also performs the function of the playback engine 514 by playing back the processed packets to the destination codec 1224. When there are gaps in the packet stream, the destination AAL2/SSCS processor 1222 inserts the comfort noise. Of course, where the destination 1206 now becomes the sender, the whole process is reversed, and the mapping module 1216 and memory system 1218 now operate to perform the mapping function according to the disclosed mapping architecture.

Although the preferred embodiment has been described in detail, it should be understood that various changes, substitutions, and alterations can be made therein without departing from the spirit and scope of the invention as defined by the appended claims.

What is claimed is:

1. A method of generating a playback time from a packet, comprising the steps of:
inputting a packet sequence number of the packet into a mapping module, which packet is associated with an arrival time; and
mapping the packet sequence number to expected playback time data utilizing the mapping module, which mapping is based upon an interpretive window, and which expected playback time data is associated with the arrival time.

2. The method of claim 1, wherein the packet in the step of inputting is utilized in an AAL2/SSCS voice architecture.

3. The method of claim 1, wherein the arrival time is a local time that is recorded when the packet was received into the mapping module in the step of inputting.

4. The method of claim 1, wherein the packet sequence number is no more than four bits resolution and the expected playback time data in the step of mapping is more than four bits resolution.

5. The method of claim 1, wherein the packet in the step of inputting has a payload that is different in size from the payload of a subsequent packet received in the step of inputting.

6. The method of claim 1, wherein the packet sequence number in the step of mapping is mapped to one arrival window in a series of arrival windows, which one arrival window corresponds to the expected playback time data, and which each arrival window in the series of arrival windows define a unique range of the arrival times.

7. The method of claim 6, wherein the packet sequence number is utilized to determine which one series of a plurality of series of the arrival windows is selected to obtain the expected playback time data.

8. The method of claim 6, wherein the unique range of arrival times of the arrival window is further defined as a plurality of packet payload times, which packet payload time is a time associated with the size of a payload of the packet.

9. The method of claim 6, wherein a local clock steps the interpretive window through the plurality of series of arrival windows to provide the association between the packet sequence number and the expected playback time data.

10. The method of claim 1, wherein the mapping module in the step of mapping accesses a database, which database includes mapping parameters that are updated according to a location of the interpretive window and associated packet sequence number information.

11. The method of claim 10, wherein the mapping module includes a database request manager that arbitrates access to the database so that a first read-write operation of the database is completed before a second read-write operation of the database is allowed.

12. The method of claim 10, wherein when the packet arrives, the mapping module in the step of mapping accesses the database for the status of the interpretive window, and either discards the packet or determines the expected playback time data based upon the mapping parameters associated with the interpretive window.

13. The method of claim 1, wherein the expected playback time data in the step of mapping includes a translation factor, which translation factor is additive and, includes at least one of a programmable playback delay and a clock differential between a remote clock and a local clock.

14. The method of claim 1, wherein the mapping module in the step of mapping includes a scheduler that triggers for playback one or more packet streams in a time-indexed data structure, which the one or more packet streams are each associated with a respective time index, and which only the one or more packet streams having the associated time index that matches the current time, are played back.

15. The method of claim 14, wherein the time-indexed data structure associates to the time index at least one of a next event, payload size, a next event time index, and a previous event.

16. The method of claim 1, wherein the step of mapping further includes the steps of determining if a change in the size of a payload of the packet has occurred, and in response to a changed payload size,
adjusting translation information utilized to translate the packet sequence number to the expected playback time data; and
interrupting a scheduler to adjust a frequency at which the interpretive window shifts.

17. The method of claim 16, wherein the changed payload size in the step of detecting is detected by at least one of an arrival engine and a sliding window engine.

18. The method of claim 16, wherein when the packet with the changed payload size arrives substantially in the middle of an associated arrival window, a next event time is queued by the scheduler, which next event time is defined as a current time plus a payload time that is associated with the changed payload size.

19. The method of claim 16, wherein when the packet with the changed payload size arrives either substantially late in an associated arrival window or outside the associated arrival window, the scheduler in the step of interrupting dequeues an event associated with an old payload size, and requeues an event associated with the changed payload size such that the frequency of the interpretive window is adjusted.

20. A method of generating a playback time from a packet sequence number, comprising the steps of:
inputting a packet sequence number of the packet into a mapping module, which packet is associated with an arrival time;
determining if a change in the size of a payload of the packet has occurred; and
mapping the packet sequence number to expected playback time data utilizing the mapping module, which mapping is based upon an interpretive window, and which expected playback time data is associated with the arrival time.

21. The method of claim 20, wherein in response to a change in payload size in the step of determining, performing the further steps of:
adjusting translation information utilized to translate the packet sequence number to the expected playback time data; and
interrupting a scheduler to adjust a frequency at which the interpretive window shifts.

22. The method of claim 20, wherein the step of mapping further comprises the steps of:
providing a series of arrival windows associated with the packet sequence number, which series of arrival windows includes one arrival window that corresponds to the expected playback time data, and which each arrival window in the series of arrival windows defines a unique range of the arrival times, and
clocking the interpretive window through the series of arrival windows to define the association between the packet sequence number and the expected playback time data.

23. The method of claim 20, wherein the packet in the step of inputting conforms to an AAL2/SSCS architecture and the expected playback time data of the packet is of a higher resolution than the packet sequence number.

24. Architecture for generating a playback time from a packet, comprising:
a processing system for receiving the packet, and extracting a packet sequence number therefrom, which packet has an associated arrival time; and
a mapping module for mapping the packet sequence number to expected playback time data, which mapping is based upon an interpretive window, and which expected playback time data is associated with the arrival time.

25. The architecture of claim 24, wherein the packet is utilized in an AAL2/SSCS voice architecture.

26. The architecture of claim 24, wherein the arrival time is a local time that is recorded when the packet was received into the mapping module.

27. The architecture of claim 24, wherein the packet sequence number is no more than four bits resolution and the expected playback time data is more than four bits resolution.

28. The architecture of claim 24, wherein the packet has a payload different in size from a payload of a subsequent packet received.

29. The architecture of claim 24, wherein the packet sequence number is mapped to one arrival window in a series of arrival windows, which one arrival window corresponds to the expected playback time data, and which each arrival window in the series of arrival windows defines a unique range of the arrival times.

30. The architecture of claim 29, wherein the packet sequence number is utilized to determine which one series of a plurality of series of the arrival windows is selected to obtain the expected playback time data.

31. The architecture of claim 29, wherein the unique range of arrival times of the arrival window is further defined as a plurality of packet payload times, which packet payload time is a time associated with the size of a payload of the packet.

32. The architecture of claim 29, wherein a local clock steps the interpretive window through the plurality of series of arrival windows to provide the association between the packet sequence number and the expected playback time data.

33. The architecture of claim 24, wherein the mapping module accesses a database, which database includes mapping parameters that are updated according to a location of the interpretive window and associated packet sequence number information.

34. The architecture of claim 33, wherein the mapping module includes a database request manager that arbitrates access to the database so that a first read-write operation of the database is completed before a second read-write operation of the database is allowed.

35. The architecture of claim 33, wherein when the packet arrives, the mapping module accesses the database for a status of the interpretive window, and either discards the packet or determines the expected playback time data based upon the mapping parameters associated with the interpretive window.

36. The architecture of claim 24, wherein the expected playback time data includes a translation factor, which translation factor is additive and, includes at least one of a programmable playback delay and a clock differential between a remote clock and a local clock.

37. The architecture of claim 24, wherein the mapping module includes a scheduler that triggers for playback one or more packet streams in a time-indexed data structure, which the one or more packet streams are each associated with a respective time index, and which only the one or more packet streams having the associated time index that matches the current time, are played back.

38. The architecture of claim 37, wherein the time-indexed data structure associates to the time index at least one of a next event, payload size, a next event time index, and a previous event.

39. The architecture of claim 24, wherein the mapping module determines if a change in the size of a payload of the packet has occurred, and in response to a changed payload size, adjusts translation information utilized to translate the packet sequence number to the expected playback time data, and interrupts a scheduler engine to adjust a frequency at which the interpretive window shifts.

40. The architecture of claim 39, wherein the changed payload size is detected by at least one of an arrival engine and a sliding window engine.

41. The architecture of claim 39, wherein when the packet with the changed payload size arrives substantially in the middle of an associated arrival window, a next event time is queued by the scheduler, which next event time is defined as a current time plus a payload time that is associated with the changed payload size.

42. The architecture of claim 39, wherein when the packet with the changed payload size arrives either substantially late in an associated arrival window or outside the associated arrival window, the scheduler engine dequeues an event associated with an old payload size, and requeues an event associated with the changed payload size such that the frequency of the interpretive window is adjusted.

43. Architecture for generating a playback time from a packet sequence number of a packet in a stream-based application, comprising:
an event scheduler engine for initiating control parameters for an interpretive window associated with a packet stream;
a sliding window engine for controlling the interpretive window according to the control parameters; and
an arrival engine that maps the packet sequence number to an expected playback time in accordance with an association created between the packet sequence number and the expected playback time by the interpretive window.

44. The architecture of claim 43, wherein at least one of the sliding window engine and the arrival engine signals the event scheduler engine when a change in the payload size of the packet is detected.

45. The architecture of claim 44, wherein in response to detected change in payload size, translation information utilized to translate the packet sequence number to the expected playback time data is adjusted, and the signaled event scheduler engine adjusts a frequency at which the interpretive window shifts.

46. The architecture of claim 43, wherein a series of arrival windows are generated in association with the packet sequence number, which series of arrival windows includes one arrival window that corresponds to the expected playback time, and which each arrival window in the series of arrival windows defines a unique range of the arrival times.

47. The architecture of claim 43, wherein the packet conforms to an AAL2/SSCS architecture and the expected playback time of the packet is of a higher resolution than the packet sequence number.

48. The architecture of claim 43, further comprising a database request manager that arbitrates access to a database of mapping parameters to update the mapping parameters, which database request manager that arbitrates so that a first read-write operation of the database is completed before a second read-write operation of the database is allowed.

49. The architecture of claim 48, wherein both the arrival engine and the sliding window engine access the database to update the mapping parameters according to the packet sequence number and a location of the interpretive window.
